(19) United States
(12) Patent Application Publication
(10) Pub. No.: US 2022/0063291 A1
(43) Pub. Date: Mar. 3, 2022

(54) METHOD FOR CREATING AN IMAGE ON AN INKED RIBBON DURING HOT PRESS PRINTING

(71) Applicant: Aleksandr Evgenievich VIRSHKE, Nizhnevartovsk (RU)

(72) Inventor: Aleksandr Evgenievich VIRSHKE, Nizhnevartovsk (RU)

(21) Appl. No.: 17/414,702

(22) PCT Filed: Feb. 14, 2019
(86) PCT No.: PCT/RU2019/000090

§ 371 Date: Jun. 16, 2021

(30) Foreign Application Priority Data
Dec. 17, 2018 (RU) 2018144663
Dec. 24, 2018 (RU) 2018145885

(51) Int. Cl. B41J 2/325

(52) U.S. Cl. CPC B41J 2/325

(57) ABSTRACT

The group of inventions relates to surface printing by transferring an image from an ink ribbon and can be applied in the printing industry. The technical result to be achieved by the group of inventions is to reduce the number of separate stages and operations in hot press printing. The nature of the group of inventions involves the use of a thermal transfer printhead for hot press printing, hot press printing method and a printing unit.

The group of inventions relates to surface printing by transferring an image from an ink ribbon and can be applied in the printing industry.

The method of hot stamping and system for implementing this method is known, including making a steel plate cliche in the form of a negative image, installing the cliche in the hot stamping press and transferring the image from the foil for hot stamping on the surface by exposure to the heated cliche [RU2243905, published on: Sep. 20, 2004, B44C 1/24].

The disadvantage of the known technical solution is the fact that in order to obtain a new image it is necessary to produce a new steel plate cliche, which greatly complicates the process of printing an image on the surface by hot stamping.

There is a known method of printing an image on a surface and a system for implementing this method, comprising preparing a transfer paper with an image and transferring the image from the transfer paper to a T-shirt, while the transfer paper is prepared by manually aligning an adhesive film having a negative image with the transfer paper and applying a heat press machine thereto, and the image from the transfer paper is transferred to the T-shirt after manually separating the adhesive film from the transfer paper, by aligning manually the transfer paper having the positive image with the T-shirt, and applying a heat press machine thereto. [IP526301, published on: Aug. 14, 2013, International Patent Classification: B41M 5/00, B41M 5/382, B41M 5/398].

The advantage of the known technical solution is that there is no need to make a new steel plate cliche for each new image, which greatly simplifies printing using a heat press machine. However, its disadvantage is that the range of ready-made adhesive films with negative images used for imaging is limited.

A method of printing an image on a free-form surface and a system for implementing this method was chosen as a prototype. They involve preparation of a hot stamping foil with an image with a laser printer and a laminating device and transfer of the image from hot stamping foil to the surface with a hot stamping press; while in a laser printer, toner is applied to the lamination film according to the negative image shape, and the laminating device provides for aligning the lamination film with the hot stamping foil and heating the combined film and foil, and the image from the hot stamping foil is transferred to the surface after the lamination film is manually separated from the foil, the foil with a positive image is manually aligned with the surface and subject to hot stamping press [RU2185289, publication date: Jul. 20, 2007, International Patent Classification: B41M 1/12].

The advantage of the prototype is that a film with a negative image can be quickly created with a laser printer. However, a common disadvantage of the prototype and the known technical solution is the low efficiency and speed of printing given that an image on the transfer paper is formed in several separate stages, each of which implies several operations between printing a negative image on an adhesive film and obtaining a positive image on an ink film. This disadvantage is due to the fact that preparation of transfer paper or foil for hot stamping with an image used for printing in a heat press machine and a hot stamping press involves separate additional devices, such as a laser printer to apply an adhesive layer (in the form of toner) to lamination film according to the negative image shape, then a laminating device to bond the film to the transfer paper or foil for hot stamping. In doing so, a heat press machine for printing or a hot stamping press reconfigured to ensure the film is bonded with paper or hot stamping foil can be used instead of a laminating device. However, the use of these devices for these purposes in large-scale printing production is ineffective and complicates the printing process. The efficiency of printing by means of known devices is impaired by the need to manually separate the lamination film from the transfer paper or hot stamping foil and manually align the transfer paper or foil for hot stamping with a positive image with the surfaces to be printed, which results in a significant increase of time and labor costs when implementing the above methods using the systems offered.

The technical problem to be solved by the group of inventions is to simplify the hot press printing procedure.

The technical result to be achieved by the group of inventions is to reduce the number of separate stages and operations in hot press printing.

The nature of the group of inventions is as follows.

Application of a thermal transfer printhead for hot press printing.

Hot press printing is different in that it includes alignment of the ink ribbon and the adhesive tape, forming an image on the ink ribbon by applying a thermal transfer printhead to the adhesive tape according to the negative image shape, separation of the ink ribbon and adhesive tape and transfer of the image from the ink ribbon to the surface by hot pressing.

Method of imaging on an ink ribbon in hot press printing is different in that it includes alignment of the ink ribbon and the adhesive tape and the application of a thermal transfer printhead to the adhesive tape according to the negative image shape.

The printing unit, in contrast to the prototype, contains a device for preparing a ribbon with an image, containing an ink ribbon feed unit, an adhesive tape feed unit and a heat imaging unit in the form of a thermal transfer printhead, and a device for transferring the image front the ribbon to the surface by hot pressing installed in a way ensuring consistent surface alignment of the ink ribbon and the adhesive tape, heat imaging on the aligned ribbon and tape by the application of thermal transfer printhead to the adhesive tape, separation of the ribbon and tape front each other and transfer of the image from the ribbon to the surface by a heat press machine.

In contrast to the prototype, the device for preparing a ribbon with an image within the printing unit contains an ink ribbon feed unit, an adhesive tape feed unit and a heat imaging unit in the form of a thermal transfer printhead, and the units are installed in a way ensuring surface alignment of the ink ribbon and the adhesive tape, and heat imaging on the aligned ribbon and tape by the application of thermal transfer printhead to the adhesive tape.

The ink ribbon contains an ink layer, which may be a pigment mixed with wax and/or resin and other similar substances, and may additionally contain a primer layer to facilitate removal and transfer of the ink layer. For example, the ink ribbon may be a thermal transfer ink ribbon, or a hot and cold stamping ribbon or foil and other known printing ink ribbons. The adhesive tape contains an adhesive layer, which may be a thermal-sensitive adhesive based on ethylene vinyl acetate, or another substance with similar properties. The ink ribbon and adhesive tape have a support ensuring their integrity and strength. Such support may be made of a film based on polypropylene, polyester, laysan or mersilene. If the activation temperature of the adhesive layer of the adhesive tape is higher than the temperature of the thermal response of its support, the adhesive tape may additionally contain an antistatic layer of polypropylene, polytetrafluoroethylene, fluoroplastic or silicone.

The device for preparing a ribbon with an image allows for obtaining an ink ribbon or adhesive tape with an image and contains an ink ribbon feed unit, an adhesive tape feed unit and a heat imaging unit in the form of a thermal transfer printhead.

A device for transferring the image from the ribbon to the surface makes it possible to place an object into the unit on the surface of which the image is applied, position the object with the required surface and print an image from the ribbon on the surface and may contain a unit for positioning the ribbon with the image relative to the surface, a unit for pressing the ribbon with the image to the surface and unit for transferring the image from the ribbon to the surface by hot pressing.

The device for preparing a ribbon with an image and the device for transferring the image from the ribbon to the surface are arranged in a way ensuring surface alignment of the ink ribbon and adhesive tape, heat imaging on the aligned ribbon and tape. separation of the ribbon and tape from each other and transfer of the image from the ribbon to the surface.

The alignment of the ink ribbon and the adhesive tape allows the ink and adhesive layers to come into contact. In this case, the ribbon and the tape can be aligned with the ink ribbon being pressed to improve adhesion between the ink and adhesive layers. Surface alignment of the ink ribbon and adhesive tape is accomplished with the ink ribbon and adhesive tape feed units. Moreover, the ink ribbon feed unit allows for feeding a ribbon with an ink layer (hot stamping ink ribbon, ink foil and other printing tapes with an ink layer) into the unit, and the adhesive tape feed unit allows for feeding a tape with an adhesive layer (laminating tape, or other types of polygraphic tapes with an adhesive layer) into the unit. To be able to align surfaces of the ink ribbon and the adhesive tape. the units can be designed and/or installed relative to each other to feed the ink ribbon and the adhesive tape with their surfaces opposite each other. The ink ribbon and adhesive tape feed units may contain ribbon spools or shafts for installing ribbon spools. The shafts can be also equipped with actuators for changing ribbon feed speed.

Forming an image on the ink ribbon by applying a thermal transfer printhead on the adhesive tape according to the negative image shape makes it possible to activate the adhesive layer on the adhesive tape and attach the ink layer of the ink ribbon thereto without direct contact of the thermal transfer printhead with the ink ribbon, which makes it possible to use ink ribbons that do not have a protective antistatic coating for thermal transfer printing. To enable imaging on the aligned ribbon and tape, the heat unit can be placed relative to the ink ribbon and adhesive tape feed units in a way ensuring the aligned ink ribbon and adhesive tape. The heat unit in the form of a thermal transfer printhead may contain a pressing element in the form of a roll, roller or a guide to improve the adhesive interaction between the adhesive and the ink layer of the aligned ribbon and tape.

Separation of the ink ribbon and adhesive tape allows for removal of the ink layer in the form of a negative image from the ink ribbon and can be done by any known means, for example, by pulling the edges in opposite directions. The image from the ink ribbon is transferred to the surface by aligning the remaining ink layer in the form of a positive image on the ink ribbon with the surface. In this case, the method of transferring the image from the ink ribbon to the surface can be selected based on hernial and deformational stability of the ink ribbon used and may include treatment by a heating roller or a hot plate, while the temperature and pressing force arc selected in accordance with the requirements of the ink ribbon. For example, a hot stamping ribbon may be treated by a hot plate at 90° C. That said, before transferring the image to the surface, the ink ribbon can be aligned or tensioned with rolls and rollers.

The ink ribbon and adhesive tape are separated with a device for preparing a ribbon with an image and a device for transferring the image from the ribbon to the surface. Furthermore, to enable separation of the ribbon and the tape, the devices can be arranged relative to each other so that when the ribbon leaves the device for preparing a ribbon with an image, the ribbon and the tape can be separated from each other, and the ribbon with an image can be transferred to the device for transferring the image from the ribbon to the surface. When it is difficult or impossible to install the said devices to ensure ribbon and tape separation, the printing unit may additionally include a separation device that may contain a set of rollers and guides that provide mechanical separation of the ribbon and the tape and/or movement of the tapes in different directions.

The transfer of an image from a ribbon to a surface by hot pressing is done using a device for transferring the image from the ribbon to the surface by hot pressing, which may contain a unit for positioning the ribbon with the image relative to the surface, a unit for pressing the ribbon with the image to the surface and unit for transferring the image from the ribbon to the surface by hot pressing. In order to be able to transfer an image from a ribbon to a surface, the units can be arranged relative to each other in a way that makes it possible to place an object into the unit on the surface of which the image is applied, position the object with the required surface opposite the image, press the ribbon with the image to the surface and transfer the image from the ribbon to the surface.

The unit for positioning the ribbon with the image relative to the surface allows for aligning and tensioning the ribbon with the image for accurate alignment of the image with the surface and may consist of one or more tension rolls, tension rollers, tension guides, etc. The unit for pressing the ribbon with the image to the surface allows for bonding the ribbon with the image with the surface and may consist of one or more pressure rolls, pressure rollers, pressure guides, etc.

The unit for transferring the image from the ribbon to the surface by hot pressing makes it possible to detach the image from the ribbon and attach the image to the surface. The unit for transferring the image from the ribbon to the surface by hot pressing can be designed to affect the ribbon and/or the surface onto which the image is transferred. The unit for transferring the image from the ribbon to the surface by hot pressing can be also designed according to the specification for the ribbon from which the image is transferred, and allow for softening the layer that connects the image to the ribbon and activating the layer that connects the image to the surface. To achieve that, the unit for transferring the image from the ribbon to the surface by hot pressing contains a heat transfer element and a pressure transfer element, which can be selected or combined depending on the compositional characteristics of the layer connecting the image with the ribbon and the layer connecting the image with the surface. The heat transfer element may be a spiral or spot heater, or an infrared lamp, etc., and the pressure transfer element may be a plate. That said, to improve performance of the printing unit, the pressure transfer element may consist of one or more rolls.

Additionally, the unit can be equipped with a tensioner to reduce the sag risk at any stage. The tensioner may contain one or more tension rolls, rollers or guides, which can be equipped with actuators.

The printing unit can also include a used ribbon collector, which makes it possible to use multi-pass printing tapes in the printing unit. This being the case, the used ribbon collector may contain ribbon spool boxes or shafts for installing ribbon spool boxes, which can be equipped with actuators.

To ensure a preset sequence of actions, the units of the printing unit can have a structural connection made in any known manner using any known structural materials.

The group of inventions is defined by a combination of essential features unknown in the prior art, which involves alignment of the ink ribbon and the adhesive tape, forming an image on the ink ribbon by the application of a thermal transfer printhead to the adhesive tape according to a negative image shape, separation of the ink ribbon and adhesive tape and transfer of the image from the ink ribbon to the surface by hot pressing, allowing for reduction of operations between imaging and image transfer to the surface by hot pressing due to the simultaneous forming of a negative image on the adhesive tape and a positive image on the ink ribbon with selective application of the thermal transfer printhead to the adhesive tape, thereby ensuring achievement of the technical result to reduce the number of separate stages and operations in hot press printing, thereby simplifying image printing by hot pressing.

The combination of essential features of the group of inventions is unknown in the prior art, suggesting that the group of inventions meets the ‘novelty’ patentability criterion.

Application of a thermal transfer printhead for hot press printing is known in the prior art. However, the use of a thermal transfer printhead is not mentioned in hot pressing process, and its application to the adhesive tape according to the negative image shape, allowing you to immediately obtain the final positive image on the ink ribbon without additional operations is left largely unaddressed in the prior art, suggesting that the group of inventions meets the ‘inventive step’ patentability criterion.

The group of inventions can be implemented using known means, materials and technologies, suggesting that the group of inventions meets the ‘industrial applicability’ patentability criterion.

The group of inventions is interrelated and forms a single inventive concept, such that the printing unit makes it possible to implement the hot press printing method and the method of forming an image on an ink ribbon in hot press printing, and together they allow for using a thermal transfer printhead in surface printing by hot pressing, which brings to a conclusion that the group of inventions meets the ‘unity of invention’ patentability criterion.

The group of inventions is illustrated by the following figures.

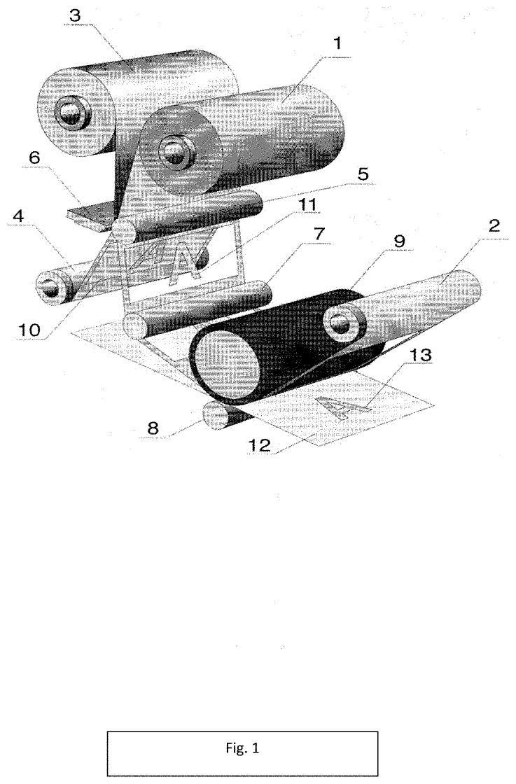

FIG. 1—Printing unit, general view.

The printing unit contains a device for preparing a ribbon with an image and a device for transferring the image from the ribbon to the surface. The device for preparing a ribbon with an image contains an ink ribbon feed unit, an adhesive tape feed unit and a heat imaging unit, while the ink ribbon feed unit contains spool 1 and spool box 2 of the ink ribbon, the adhesive tape feed unit contains spool 3 and spool box 4 of the adhesive tape, and the heat imaging unit contains pressure roll 5 and thermal transfer printhead 6. The device for transferring the image from the ribbon to the surface contains a unit for positioning the ribbon with the image, a unit for pressing the ribbon with the image and unit for transferring the image from the ribbon to the surface, while the positioning unit contains tension roll 7, the pressing unit contains pressure roll 8, and the image transfer unit contains preheat roll 9.

Spool 1 and spool 3 are arranged to ensure positioning of the ink ribbon and adhesive tape opposite each other, pressure roll 5 and thermal transfer printhead 6 are arranged relative to spool 1 and spool 3 in a way to ensure surface alignment of the ink ribbon and adhesive tape and the application of thermal transfer printhead 6 to the adhesive tape according to the image shape, spool box 4 is installed relative to spool box 2 to ensure separation of the ink ribbon from the adhesive tape, and tension roll 7, preheat roll 9 and pressure roll 8 are arranged to ensure the transfer of the image from the ink ribbon to the surface.

The group of inventions is implemented as follows.

Spool 1 and spool box 2 of the ink ribbon, as well as the spool 3 and spool box 4 of the adhesive tape are mounted in the printing unit in a way that the ink and adhesive layers are opposite each other. When the unit is started, the ink ribbon and the adhesive tape move, align with each other and are pressed against thermal transfer printhead 6 by pressure roll 5; at this time, the adhesive tape is exposed to a pulsed spot heating by the thermal transfer printhead, resulting in the activation of thermal-sensitive adhesive layer according to the negative image shape and attachment of the ink ribbon's ink layer to the adhesive tape.

The adhesive tape is wound on spool box 4 and is separated from the ink ribbon, whereby negative image 10 is separated and positive image 11 remains on the ink ribbon. The ink ribbon is aligned by guide roll 7 and positive image 11 is aligned with surface 12. Positive image 11 is pressed to surface 12 by auxiliary roll 8 and preheat roll 9, and, when heated by preheat roll 9, the bonding layer of the ink ribbon softens and positive image 11 is transferred to surface 12, and the used ink ribbon is wound on spool box 2. This ensures the transfer of image 13 to surface 12 by the printing unit.

That way the technical result which involves reduction of the number of separate stages and operations in hot press printing is achieved, thereby hot press printing is simplified.

1. (canceled)

2. (canceled)

3. (canceled)

4. (canceled)

5. (canceled)

6. (canceled)

7. (canceled)

8. The printing unit characterized by containing a device for preparing a ribbon with an image, containing an ink ribbon feed unit, an adhesive tape feed unit and a heat imaging unit in the form of a thermal transfer printhead, and a device for transferring the image from the ribbon to the surface by hot pressing installed in a way ensuring consistent surface alignment of the ink ribbon and the adhesive tape heat imaging on the aligned ribbon and tape by the application of thermal transfer printhead to the adhesive tape, separation of the ribbon and tape from each other and transfer of the image from the ribbon to the surface by a heat press machine.

9. The unit claimed in claim 8 characterized in that the device for transferring the image from the ribbon to the surface by hot pressing includes a unit for transferring the image from the ribbon to the surface by hot pressing.

10. The unit claimed in claim 9 characterized in that the unit for transferring the image from the ribbon to the surface by hot pressing is designed to affect the ribbon with the image.

11. The unit claimed in claim 9 characterized in that the unit for transferring the image from the ribbon to the surface contains a heat transfer element and a pressure transfer element, which are combined depending on the compositional characteristics of the layer connecting the image with the ribbon and the layer connecting the image with the surface.

12. The unit claimed in claim 11 characterized in that the pressure transfer element for transferring the image from the ribbon to the surface is designed as a roll.

13. The unit claimed in claim 9 characterized in that the device for transferring the image from the ribbon to the surface includes a unit for positioning the ribbon with the image relative to the surface and/or a unit for pressing the ribbon with the image to the surface.

14. The unit claimed in claim 8 characterized by availability of a separation device.

15. The unit claimed in Claim 8 characterized by availability of a tensioner.

16. The unit claimed in claim 8 characterized by availability of a used ribbon collector.

17. (canceled)

18. (canceled)

19. (canceled)

20. (canceled)
